(19) United States
(12) Patent Application Publication
(10) Pub. No.: US 2026/0350279 A1
(43) Pub. Date: Nov. 5, 2026

(54) ELECTROMAGNETIC CO-SIMULATION OF MULTI-PROCESSES, PACKAGING AND SYSTEMS

(71) Applicant: Lorentz Solution, Inc., Santa Clara, CA (US)

(72) Inventors: Jinsong Zhao, Palo Alto, CA (US); Hyungon Kim, Fremont, CA (US); Xiaodong Shi, Santa Clara, CA (US); Jose Isaac Santos Batista, Santa Clara, CA (US)

(21) Appl. No.: 19/253,459

(22) Filed: Jun. 27, 2025

Related U.S. Application Data
(60) Provisional application No. 63/798,425, filed on May 1, 2025.

(51) Int. Cl. G06F 30/32

(52) U.S. Cl. CPC G06F 30/32

(57) ABSTRACT

This present disclosure provides a flexible and scalable method of combining multiple process technologies for EM simulation purposes regardless of the EM simulation algorithm and numerical method of the EM software/tool. This method simplifies the current solutions for integrating material processes, which may require modifications of the individual material profiles as well as the definition of a combined material profile. This method is broadly applicable to the latest integration of chiplets, where the current applications demand high communication speed with chiplets working at high operating frequencies, requiring an accurate, scalable and reliable EM modeling method.

### CLAIM OF PRIORITY

This application claims the benefit of U.S. Provisional Application No. 63/798,425, filed May 1, 2025, the entire contents of which are incorporated herein by reference.

### BACKGROUND

The microelectronic industry has shifted from a monolithic chip approach, where all functionalities (e.g., memory, CPU, communication) are integrated into a single die, to the use of specialized chiplets that are assembled within a single package. Recent advances in artificial intelligence (AI) and high-performance computing have increased the demand for high-density interconnections to support high-speed communication, low latency, and low signal loss. These requirements have driven the development of 2.5D chiplet interconnection methods, which utilize interposer structures for horizontal connectivity. However, even higher connection densities are still needed. Three-dimensional integrated circuit (3DIC) architectures introduce the stacking of chiplets directly on top of one another, a configuration often referred to as systems on integrated chips (SoIC). A 3DIC architecture enables vertical interconnection between chiplets, reducing interconnect distances and enhancing high-speed, low-latency, and low-loss communication.

Traditionally, certain EM tools have focused on simulating onchip layouts, while others have targeted packaging and printed circuit board (PCB) designs. However, with evolving industry demands, EM co-simulation across multiple process technologies has become critical for ensuring signal integrity, electromagnetic compatibility, and design sign-off. EM simulation requires reliable definitions of various parameters, including material properties and the dimensions of multiple metal and dielectric layers. This becomes challenging for conventional EM tools when dealing with multiple process technologies, each involving distinct material specifications. These challenges underscore the need for a reliable and scalable method to integrate multiple process technologies—capable of combining an unlimited number of layers in arbitrary configurations—without requiring modifications to layout environments or process design kits (PDKs).

### SUMMARY

A first aspect of the present disclosure provides a method for device simulation. The method includes receiving two or more process technology profiles, and obtaining, for co-simulation based on the two or more process technology profiles, a stackup of layers comprising two or more profile layers and a connection between adjacent profile layers of the two or more profile layers. Each profile layer corresponds to a process technology profile. The connection comprises definitions of connectivity between the adjacent profile layers.

According to an embodiment of the first aspect, the method also includes receiving two or more layout designs, each layout design corresponding to a process technology profile of the two or more process technology profiles, generating, based on the stackup of layers and the two or more layout designs, a combined device stacking individual devices corresponding to the two or more process technology profiles, and performing co-simulation on the combined device and producing co-simulation results.

According to an embodiment of the first aspect, performing co-simulation on the combined device and producing co-simulation results includes: generating one or more output models based on the combined device. The one or more output models comprise interactions between two or more process technologies corresponding to the two or more process technology profiles.

According to an embodiment of the first aspect, the one or more output models comprise an electromagnetic (EM) model that simulates EM behaviors in the combined device.

According to an embodiment of the first aspect, obtaining the stackup of layers is carried out by executing a connection file. The connection file includes one or more of: a definition of a combination of the two or more process technology profiles and an integration therebetween, name and layer specifications, connectivity information, or separation and orientation between two or more process technologies corresponding to the two or more process technology profiles.

According to an embodiment of the first aspect, the connection file defines, based on user input or default configuration, an arbitrary combination of technology profiles from the two or more process.

According to an embodiment of the first aspect, obtaining the stackup of layers includes: obtaining, from a plurality of stackups of layers corresponding to a plurality of combinations of process technology profiles stored in a storage medium, the stackup of layers corresponding to the two or more process technology profiles. The plurality of stackups of layers corresponding to the plurality of combinations of process technology profiles are generated based on one or more connection files.

According to an embodiment of the first aspect, the two or more process technology profiles correspond to two or more different process technologies. The two or more process technologies includes one or more of: one or more advanced node process technologies, at least one process technology for interposer technologies, at least one process technology for packaging technologies, or at least one process technology for printed circuit board (PCB) technologies.

According to an embodiment of the first aspect, the combined device is integrated based on at least one of the following integration technologies: Wafer-on-Wafer (WoW), integration of electronic and photonic chiplets (EIC-PIC), Chip-on-Wafer-on-Substrate (CoWoS), Embedded Multi-Die Interconnect Bridge, integration of two or more integrated circuits (ICs) through interposer interconnection (IC-IC-Interposer), flip-chip packaging integration, or IC-Package-PCB (IC-PKG-PCB).

A second aspect of the present disclosure provides a system for device simulation. The system includes one or more processors configured to: receive two or more process technology profiles, and obtain, for co-simulation based on the two or more process technology profiles, a stackup of layers comprising two or more profile layers and a connection between adjacent profile layers of the two or more profile layers

According to an embodiment of the second aspect, the one or more processors are further configured to: receive two or more layout designs, each layout design corresponding to a process technology profile of the two or more process technology profiles, generate, based on the stackup of layers and the two or more layout designs, a combined device stacking individual devices corresponding to the two or more process technology profiles, and perform co-simulation on the combined device and producing co-simulation results.

According to an embodiment of the second aspect, performing co-simulation on the combined device and producing co-simulation results includes: generating one or more output models based on the combined device. The one or more output models comprise interactions between two or more process technologies corresponding to the two or more process technology profiles.

According to an embodiment of the second aspect, the one or more output models comprise an electromagnetic (EM) model that simulates EM behaviors in the combined device.

According to an embodiment of the second aspect, obtaining the stackup of layers is carried out by executing a connection file. The connection file includes one or more of: a definition of a combination of the two or more process technology profiles and an integration therebetween, name and layer specifications, connectivity information, or separation and orientation between two or more process technologies corresponding to the two or more process technology profiles.

According to an embodiment of the second aspect, the connection file defines, based on user input or default configuration, an arbitrary combination of technology profiles from the two or more process.

According to an embodiment of the second aspect, obtaining the stackup of layers includes: obtaining, from a plurality of stackups of layers corresponding to a plurality of combinations of process technology profiles stored in a storage medium, the stackup of layers corresponding to the two or more process technology profiles. The plurality of stackups of layers corresponding to the plurality of combinations of process technology profiles are generated based on one or more connection files.

According to an embodiment of the second aspect, the two or more process technology profiles correspond to two or more different process technologies. The two or more process technologies includes one or more of: one or more advanced node process technologies, at least one process technology for interposer technologies, at least one process technology for packaging technologies, or at least one process technology for printed circuit board (PCB) technologies.

According to an embodiment of the second aspect, the combined device is integrated based on at least one of the following integration technologies: Wafer-on-Wafer (WoW), integration of electronic and photonic chiplets (EIC-PIC), Chip-on-Wafer-on-Substrate (CoWoS), Embedded Multi-Die Interconnect Bridge, integration of two or more integrated circuits (ICs) through interposer interconnection (IC-IC-Interposer), flip-chip packaging integration, or IC-Package-PCB (IC-PKG-PCB).

A third aspect of the present disclosure provides non-transitory computer-readable medium, having stored thereon a set of instructions, which if performed by one or more processors, cause the one or more processors to: receive two or more process technology profiles, and obtain, for co-simulation based on the two or more process technology profiles, a stackup of layers comprising two or more profile layers and a connection between adjacent profile layers of the two or more profile layers. Each profile layer corresponds to a process technology profile. The connection comprises definitions of connectivity between the adjacent profile layers.

According to an embodiment of the third aspect, the set of instructions, which if performed by one or more processors, further cause the one or more processors to: receive two or more layout designs, each layout design corresponding to a process technology profile of the two or more process technology profiles, generate, based on the stackup of layers and the two or more layout designs, a combined device stacking individual devices corresponding to the two or more process technology profiles, and perform co-simulation on the combined device and producing co-simulation results.

### BRIEF DESCRIPTION OF THE DRAWINGS

The present systems and methods for electromagnetic co-simulation of multi-processes, packaging, and systems are described in detail below with reference to the attached drawing figures, wherein:

FIG. 1A illustrates an exemplary network environment, in accordance with one or more embodiments of the present disclosure.

FIG. 1B is a block diagram of an exemplary computing system configured to implement various functions, in accordance with one or more embodiments of the present disclosure.

FIG. 2A illustrates an example flow for EM simulation with one process technology, in accordance with one or more embodiments of the present disclosure.

FIG. 2B illustrates a vertical stack of components constructed using different process technologies, in accordance with one or more embodiments of the present disclosure.

FIG. 3 is flowchart illustrating a method for performing EM co-simulation, in accordance with one or more embodiments of the present disclosure.

FIG. 4A illustrates an example flow for defining the material properties of multiple process technologies, in accordance with one or more embodiments of the present disclosure.

FIG. 4B illustrates another example flow for defining the material properties of multiple process technologies, in accordance with one or more embodiments of the present disclosure.

FIG. 5 is a flow diagram illustrating a method for processing process technology profiles, in accordance with one or more embodiments of the present disclosure.

FIGS. 6A-6F illustrate examples of processing multiple process technology profiles, in accordance with some embodiments.

FIG. 7 is a flow diagram illustrating a method for processing multiple design layouts, in accordance with one or more embodiments of the present disclosure.

FIG. 8 illustrates an example flow for EM co-simulation, in accordance with an embodiment

### DETAILED DESCRIPTION

Systems and methods are disclosed herein that relate to electromagnetic (EM) co-simulation of multi-processes, packaging, and systems, and in particular, to the integration of multiple process technologies for simulation purposes. This disclosure enables three-dimensional integrated circuit (3DIC) architecture as well as the incremental combination of onchip structures with interposers (2.5D architecture), packaging, and printed circuit board (PCB) layouts. Unlike conventional EM tools, which typically require the definition of a monolithic material property file (profile) with information from different processes or Process Design Kit (PDK) modifications, the present disclosure allows the combination of multiple dedicated profiles coming from different process technologies.

In at least one embodiment, methods disclosed herein utilize a connection module (e.g., including a connection file) to specify the interconnection and orientation between the different process technologies, such as chiplet, interposer, packaging, and PCB technologies. This approach eliminates the need to modify the descriptions of the original material profiles. The method allows the scalability of EM simulations to support an unlimited number of PDKs and other technologies by requiring solely the availability of the original profiles.

In at least one embodiment, the connection module (or the connection file) expands the ability of any software to accept design layouts from multiple process technologies. For example, this allows a suitable EM simulation tool to construct a combined device consisting of individual components from multiple process technologies for EM simulation purposes regardless of the algorithm and method of the EM software.

The present disclosure discusses the combination of multiple individual profiles, the loading of layouts to multiple processes, and the definition of an environment for the EM co-simulation of combined IC, 3DIC, interposer, packaging and PCB designs. However, It will be understood by those skilled in the art that the present disclosure is applicable to a broad range of applications, including but not limited to 3DIC integration for Wafer-on-Wafer (WoW), integration of electronic and photonic chiplets (EIC-PIC), 2.5D integrations using commercial interposer technologies such as Chip-on-Wafer-on-Substrate (CoWoS) and Embedded Multi-Die Interconnect Bridge (EMIB), combinations of 3DIC and interposers (e.g., IC-IC-Interposer), conventional flip-chip packaging technology (IC-PKG), and the inclusion of PCBs (IC-PKG-PCB).

The electronic industry has evolved from a monolithic chip, package, PCB structure towards the heterogeneous integration of multiple technologies. This trend has steered design practices to meet increasingly demanding electrical, thermal, mechanical, and electromagnetic requirements. At advanced nodes, die yield decreases drastically as die size increases. This makes it more advantageous to split large monolithic chips into smaller chiplets, which can then be integrated within a single package. Similarly, heterogeneous integration enables projects that may require different technologies to satisfy dedicated needs. For example, commercial products have combined chiplets dedicated to specific tasks such as transceiver with other chiplets that may excel in other functions such as memory and I/O.

Furthermore, the latest technological breakthroughs in artificial intelligence (AI), high-performance computing, autonomous driving, etc. demand microelectronics working at extremely high-speed and low power consumption. These challenging needs have been addressed by minimizing the separation between chiplets leading to shorter interconnection generating less conductive losses with a higher communication speed. This trend drove the industry to develop new methods of integrating multiple chiplets such as the implementation of interposers for the horizontal interconnection of chiplets following a 2.5D architecture. Further requirements have pushed design practices to minimize the interconnection distance by placing chiplets vertically on top of other chiplets describing a 3DIC architecture. However, as communication speed increases, IC designs are now operating at higher frequencies, where EM effects such as vertical EM coupling and signal integrity between chiplets become critical in a 3DIC architecture. For example, data centers have recently required the development of microelectronics for photonic applications, which are responsible for transforming the light from optic fibers into electrical signals. Photonic chiplets (PIC) and electronic chiplets (EIC) are normally integrated in a compact configuration following 2.5D and 3DIC architecture. Due to the high-speed data rate application, both EIC and PIC operate a high frequency, which supports the critical need of modeling the EM interaction between the processes. Following this direction, the present disclosure allows the combination of unlimited IC process technologies as well as the integration of other technologies such as interposers, packaging and PCB designs. This type of combined design and layout environment enables the EM co-simulation of structures from multiple technologies together.

For high operating frequencies, it becomes imperative to develop an accurate EM model that describes real device performance and signal integrity metrics. Reliable EM models depend on the settings for the EM simulation tool (computational mesh and boundary conditions) as well as the reliable definition of the materials for the process technology. Conventional flow for EM software to deliver EM simulation results starts from the definition of the material properties in the shape of a process profile, which is used for accepting the design layout that corresponds to the technology process. This information is required for EM simulation and EM model generation regardless of the internal algorithms and numerical methods. Similarly, advanced integrations involving 3DIC, interposers, and conventional packaging designs require the definition of multiple material properties from different fabrication processes, where conventional EM tools have faced challenges in terms of scalability and reliability. The present disclosure introduces a versatile method for combining multiple process technologies with their specific material properties and dimensions for EM design, simulation, and verification purposes. It extends the EM simulation environment from a single process technology to multiple nodes with unlimited number of layers in an arbitrary combination.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

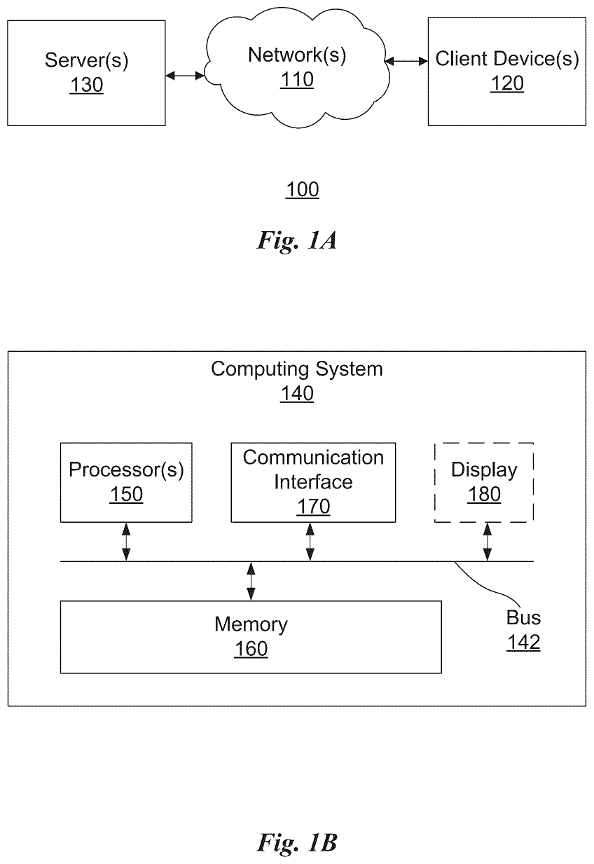

FIG. 1A illustrates an exemplary network environment 100, in accordance with one or more examples of the present disclosure. A simulation environment (or platform) may be implemented in the exemplary network environment 100. Network environments suitable for use in implementing embodiments of the disclosure may include one or more client devices 120, servers 130, and/or other device types.

Components of a network environment may communicate with each other via a network(s) 110, which may be wired, wireless, or both. By way of example, the network 110 may include one or more Wide Area Networks (WANs), one or more Local Area Networks (LANs), one or more public networks such as the Internet, and/or one or more private networks. Where the network includes a wireless telecommunications network, components such as a base station, a communications tower, or access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In at least one embodiment, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). A cloud-based network environment may be private (e.g., limited to a single organization), may be public (e.g., available to many organizations), and/or a combination thereof (e.g., a hybrid cloud environment).

By way of example and not limitation, a client device 120 may be embodied as a Personal Computer (PC), a laptop computer, a mobile device, a smartphone, a tablet computer, or any other suitable device.

FIG. 1B is a block diagram of an exemplary computing system 140 configured to implement various functions in accordance with one or more embodiments of the present disclosure. In some examples, the computing system 140 may be embodied as a client device 120 or a server 130 as shown in FIG. 1A. In another examples, the computing system 140 may include any combination of the components in the network environment 100 as shown in FIG. 1A to carry out various functions/processes disclosed herein. In yet another examples, the computing system 140 may include a cloud storage (e.g., a network attached storage (NAS) connected in the network environment 100) storing suitable data, such as various technology process profiles and one or more connection files. One or more client devices 120 and/or one or more servers 130 may retrieve data from the cloud storage to prepare for co-simulations involving different technology processes.

As shown in FIG. 1B, the computing system 140 may include one or more processors 150, a communication interface 170, and a memory 160, which are communicatively coupled to a bus 142. The one or more processors 150, communication interface 170, and memory 160 may be communicatively coupled to a bus 142 to enable communication therebetween. The processor(s) 150 may be configured to perform the operations in accordance with the instructions stored in memory 160. The processor(s) 150 may include any appropriate type of general-purpose or special-purpose microprocessor, such as central processing unit (CPU), graphic processing unit (GPU), parallel processing unit (PPU), etc. The memory 160 may be configured to store computer-readable instructions that, when executed by the processor(s) 150, can cause the processor(s) 150 to perform various operations disclosed herein. The memory 160 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), a flash memory, a dynamic random-access memory (“RAM”), and/or a static RAM.

The communication interface 170 may be configured to communicate information between the computing system 140 and other devices or systems, such as the client device(s) 120, the server(s) 130, or any other suitable device(s)/system(s) in the network environment 100 as show in FIG. 1A. For example, the communication interface 170 may include an integrated services digital network (“ISDN”) card, a cable modem, a satellite modem, or a modem to provide a data communication connection. As another example, the communication interface 170 may include a local area network (“LAN”) card to provide a data communication connection to a compatible LAN. As a further example, the communication interface 170 may include a high-speed network adapter such as a fiber optic network adaptor, 10G Ethernet adaptor, or the like. Wireless links can also be implemented by the communication interface 170. In such an implementation, the communication interface 170 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like. In some variations, the communication interface 170 may include various I/O devices such as a keyboard, a mouse, a touchpad, a touch screen, a microphone, a camera, a biosensor, etc. A user may input data to the computing system 140 (e.g., a terminal device) through the communication interface 170.

In some examples, a display 180 may be integrated as part of the computing system 140 or may be provided as a separate device communicatively coupled to the computing system 140. The display 180 may include a display device such as a Liquid Crystal Display (“LCD”), a Light Emitting Diode Display (“LED”), a plasma display, or any other type of display, and provide a Graphical User Interface (“GUI”) presented on the display for user input and data depiction. In some instances, the display 180 may be integrated as part of the communication interface 170.

Electromagnetic (EM) simulation requires accurate definitions of material properties and the physical dimensions of multiple metal and dielectric layers. EM simulation tools can perform layout-based analysis of a device within a simulation environment defined by a monolithic process technology. For example, an EM simulation environment may be defined or constrained by a set of material parameters-such as the conductivity and thickness of metal layers, and the permittivity and thickness of dielectric layers-specified by a particular process technology. This enables the simulation tool to construct the device layout in accordance with the process design rules and to apply appropriate EM models that accurately capture the device's behavior under simulated conditions.

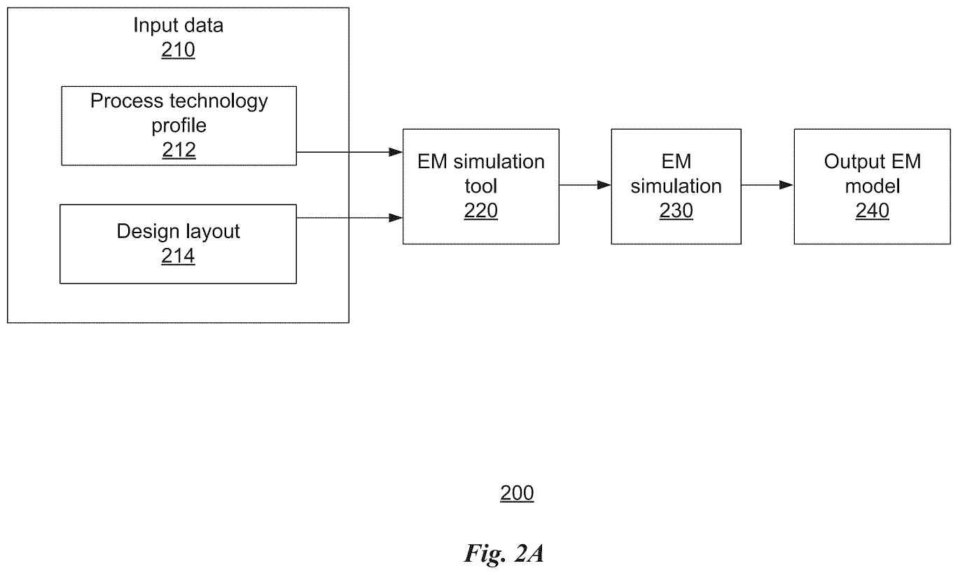

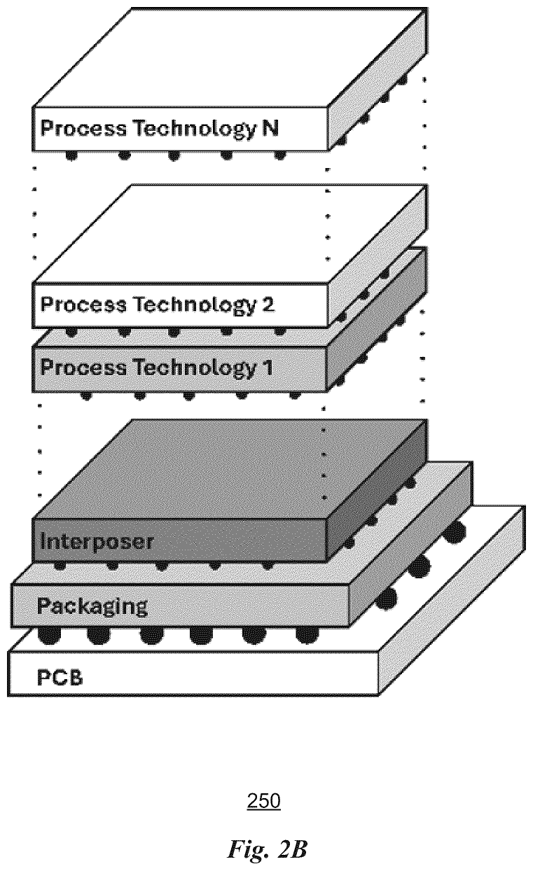

FIG. 2A illustrates an example flow 200 for EM simulation with one process technology, in accordance with one or more embodiments of the present disclosure. At block 220, an EM simulation tool obtains input data 210 to construct a device based on the specified process technology. The input data 210 includes a process technology profile 212, which defines material properties and layer structures associated with the process technology, and a design layout 214, which specifies the geometric structure of the device. For example, the process technology profile 212 defines the material characteristics necessary to accept and interpret the corresponding design layout 214. This information is essential for both EM simulation (at block 230) and EM model generation (e.g., at block 240), regardless of the specific internal algorithms or numerical methods employed. At block 230, the EM tool performs EM simulation on the constructed device, for example, by applying suitable physics models and/or numerical methods. At this stage, various physical effects can be simulated, and the device mesh can be refined or adjusted by the user to balance simulation accuracy and computational efficiency. At block 240, the EM tool outputs the resulting EM model in one or more suitable formats, as specified by user input.

As discussed earlier, advances in technology have led to increasingly complex devices composed of individual components fabricated using different process technologies. FIG. 2B illustrates a vertical stack 250 of components constructed using different process technologies, in accordance with one or more embodiments of the present disclosure. From bottom to top, the example includes a PCB layer, a packaging layer, and an interposer layer, each representing a distinct manufacturing process and set of design rules. Above the interposer layer, a stack of one or more (1-N) additional process technology layers may be included, such as logic dies, memory dies, or other specialized components. The number of stacked layers and their order can be flexibly configured based on specific application requirements, performance targets, or manufacturing constraints. In other implementations, certain components fabricated using different process technologies may also be arranged laterally—side by side on a common substrate—depending on design requirements, thermal constraints, or signal routing considerations.

Process technology refers to the specific set of manufacturing methods, material specifications, and design rules used to fabricate electronic components. The Process technology encompasses various aspects, including technology nodes (e.g., A16 (TSMC's next nanosheet-based technology), 2 nm, 3 nm, 5 nm, 10 nm, 28 nm), which define the minimum feature sizes in Complementary Metal-Oxide-Semiconductor (CMOS) processes; device types such as CMOS, Bipolar CMOS (BiCMOS), Radio Frequency CMOS (RF-CMOS), Silicon-On-Insulator (SOI), and Fin Field-Effect Transistor (FinFET), each with distinct fabrication flows; packaging technologies like flip-chip, wafer-level packaging (WLP), and fan-out WLP (FOWLP); substrate or board technologies including organic PCBs, high-density interconnects (HDI), and ceramic-based substrates like Low-Temperature Co-fired Ceramic (LTCC); and advanced integration approaches such as 2.5D and 3D stacking with interposers, Through-Silicon Vias (TSVs), and redistribution layers (RDLs). Together, these process technologies enable the design and fabrication of highly integrated and heterogeneous electronic systems.

In the context of device modeling, each process technology defines its own set of material properties, layer stacks, design rules, and dimensional tolerances. When such heterogeneous components are integrated into a single device or system, inconsistencies in material definitions, geometric alignments, and EM behavior can arise. These discrepancies pose significant challenges for accurate modeling and simulation—particularly in EM analysis, where consistent definitions of metal and dielectric properties are essential. The absence of a unified process framework complicates layout integration and can result in simulation inaccuracies, unreliable performance predictions, and potential design rule violations during fabrication.

For example, the current EM simulation needs require the integration of not only one process technology but the combination of multiple nodes, which can even be extended to interposer, packaging and PCB structures. Conventional EM tools have been developed and improved with accuracy, mesh/discretization, and modeling techniques targeted at specific technologies. There have been EM tools focused on the EM simulation of onchip structures while others have focused on the EM simulation of packaging and PCB structures. For example, some EM tools have been developed based on IC design environments, which follow a strict design flow dictated by the foundry rules in form of a PDK. However, the restrictions imposed by PDK and design rules (DRC) limit the integration with other process technologies from different foundries. PDK modification is not a simple task, and it requires a level of expertise that few Computer Aid Design (CAD) teams can support. Similarly, the material properties of advanced process technology nodes are usually encrypted, which increases the level of complexity for the definition of new architectures that involve the interaction between processes. This highlights the need for a simple, scalable, and reliable method of defining multi-process EM environment that regular designers can follow.

The present disclosure provides versatile methods for combining multiple process technologies with their specific material properties (e.g., in process technology profiles) and dimensions (e.g., in layout designs) for EM design, simulation, and verification purposes. The methods extend the EM simulation environment from a single process technology to multiple process technologies with unlimited number of layers in an arbitrary combination.

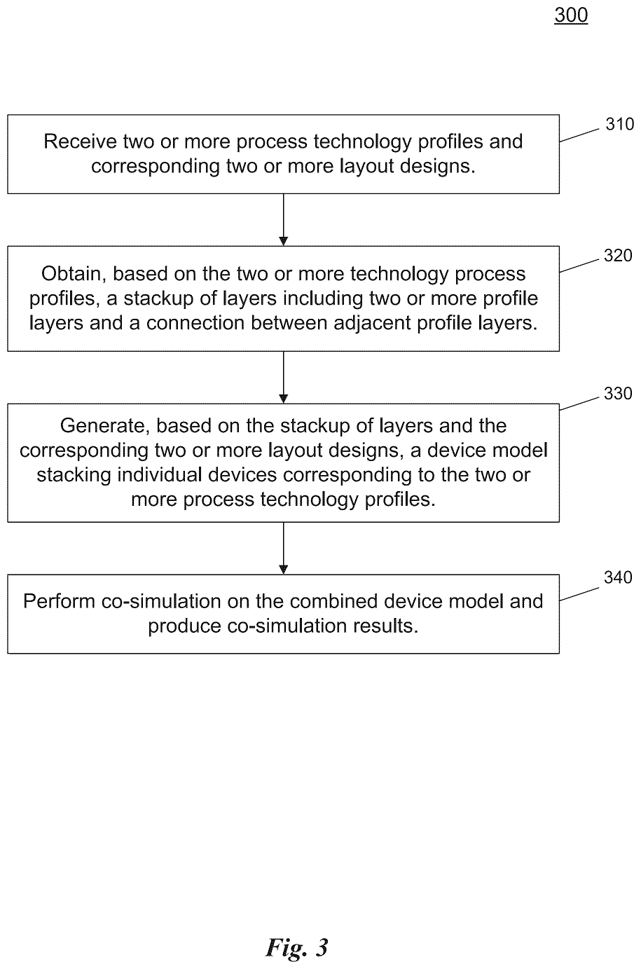

FIG. 3 is flowchart illustrating a method 300 for performing EM co-simulation, in accordance with one or more embodiments of the present disclosure. Each block of method 300, described herein, comprises a computing process that may be performed using any combination of hardware, firmware, and/or software. For example, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the computing system of FIG. 1B. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure. Additionally, it will be appreciated by persons of ordinary skill in the art that the method 300 may be performed in any suitable environment and blocks in the method 300 may be performed in any suitable order.

At block 310, the computing system receives two or more process technology profiles and corresponding two or more layout designs. The two or more process technology profiles correspond to different technology processes. Each layout design defines an individual device that is constructed in accordance with a corresponding process technology. The individual device may take the form of a structure, a discrete component, an integrated circuit, any other suitable implementation, or any combination thereof. The individual device defined by its corresponding process technology may be referred to as a component within the combined device (or device model) at block 330.

At block 320, the computing system obtains, based on the two or more process technology profiles, a stackup of layers including two or more profile layers and a connection between adjacent profile layers. Each process technology profile is represented by a corresponding profile layer in the stackup of layers. The two or more profile layers in the stackup of layers are arranged in a specific order, with each subsequent profile layer connected to the preceding profile layer.

The connection between adjacent profile layers may be implemented in various forms. In one embodiment, the connection is defined by a functional element referred to as a connection via, which enables interaction between adjacent profile layers. In another embodiment, the connection is represented by one or more connection layers. For example, a connection layer may be defined and associated with the top interface of one profile layer, and/or another connection layer may be defined and associated with the bottom interface of another profile layer. Each connection layer enables connectivity with the corresponding interface of its respective profile layer. In yet another embodiment, the connection is defined by a set of parameters that facilitate interaction between adjacent profile layers.

In at least one embodiment, the computing system executes a connection module, which may be implemented as a connection file or a generic description that defines the integration of multiple process technologies. The connection file may include predefined instructions for process integration and may also allow user input for customization. This file can be considered a functional module encoded in a computer-readable format and may be implemented using any suitable data structure or scripting language, depending on the simulation environment. In this context, the connection module serves as an executable configuration that guides the system in interpreting and combining heterogeneous process technologies.

In at least one embodiment, the connection module includes various information, such as the material properties, material dimensions, connectivity between processes, and/or vertical orientation, for EM simulation and parasitic extraction purposes. The connection module allows software (e.g., a suitable EM tool) to interact with multiple material profiles regardless of the underlying algorithms and methods.

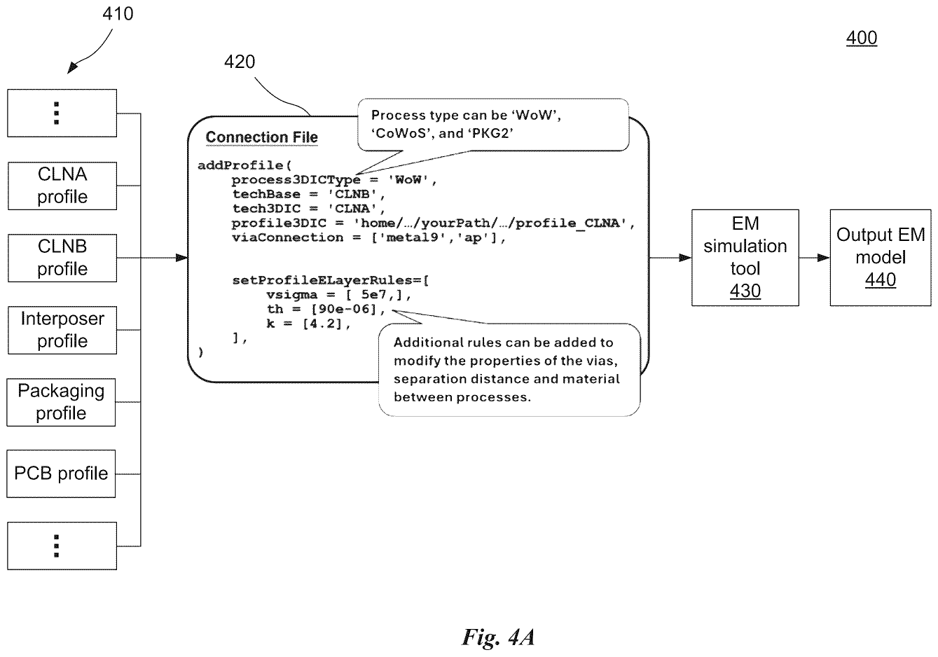

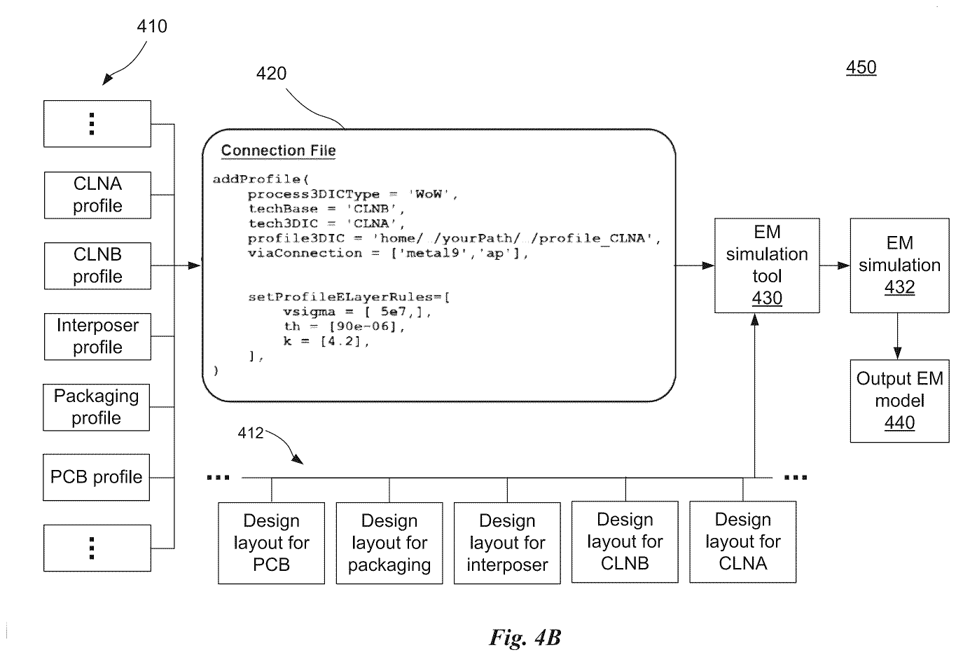

FIG. 4A illustrates an example flow 400 for defining the material properties of multiple process technologies, in accordance with one or more embodiments of the present disclosure. The figure also shows an example syntax of a connection file 420 used to define the integration from a selection of process technology profiles 410. For example, the available process technology profiles 410 include but not limited to a first process technology profile, denoted as “CLNA profile” (or “CLNA” for short), a second process technology profile, denoted as “CLNB profile” (or “CLNB” for short), a third process technology profile for interposer, denoted as “Interposer profile,” a fourth process technology profile for packaging, denoted as “Packaging profile,” a fifth process technology profile for PCB, denoted as “PCB profile,” and more. The syntax of a connection file refers to the specific structure, format, and rules used to express how different process technologies are defined and combined within a computing system. The actual syntax can vary depending on the implementation (e.g., JSON, XML, YAML, proprietary scripting format).

In the illustrated example, the connection file 420 includes the following example scripts:

Connection File

```
addProfile{
  process3DICType = ‘WoW’,
  techBase = ‘CLNB’,
  tech3DIC = ‘CLNA’,
  profile3DIC = ‘home/ .../yourPath/ .../profile_‘CLNA’,
  viaConnection = [‘metal9’ , ‘ap’],
  setProfileELayerRules = [
    vsigma = [ 5e7,],
    th = [90e−06],
    k = [4.2],
  ],
}
```

In the illustrated example, the syntax includes “process3DICType,” which may describe any of the latest integration such as Wafer-on-Wafer (WoW) as well as other integrations for interposers and packaging/PCB technologies, such as Chip-on-Wafer-on-Substrate (CoWoS), PKG2 (referring to a second-level package in a hierarchical design), and more. The syntax of the connection file 420 also describes a base process technology profile (corresponding to the “techBase” keyword), which is combined with a second process technology profile, for example, corresponding to the “tech3DIC” keyword. The syntax key word “profile3DIC” specifies the path to the second process technology profile that is to be combined with the base process technology profile, which may originate from any process technology. The connection file also includes a “viaConnection” command, which specifies the connection details between specific layers of the combined process technology profiles. For example, the command defines which material layer from the base process technology profile (e.g., “CLNB”) interfaces with which material layer from the second process technology profile (e.g., “CLNA”). An example may include connecting a layer from one of the combined profiles, such as layer “metal9” (or “M9”) in CLNB, to a layer from the added process technology profile, such as layer “ap” in CLNA. Additionally, users can specify more rules, for example, to modify the properties of the vias, the separation distance, and material between the processes under the key word “setProfileELayerRules.” Similarly, the flow 400 may implement the connection file 420 to combine the material properties from an arbitrary number of distinct process technologies in any suitable combinations and orders. This combined information (e.g., represented by a stackup of multiple connected layers) is used by any suitable EM simulation tool (e.g., at block 430) to handle multi-process designs/simulations to deliver an output model (e.g., at block 440).

In at least one embodiment, when three or more process technology profiles are to be combined, the “techBase” may refer to the starting point of the combination. For example, “techBase” indicates the first process technology profile in the resulting stackup, which may correspond to either the topmost or bottommost profile layer in the vertical stackup.

At block 330, the computing system generates, based on the stackup of layers and the corresponding two or more layout designs, a device model stacking the individual devices corresponding to the two or more process technology profiles. The two or more process technologies profiles represent different process technologies.

FIG. 4B illustrates another example flow 450 for defining the material properties of multiple process technologies, in accordance with one or more embodiments of the present disclosure. The flow 450 shares common elements with the flow 400, including the process technology profiles 410, the connection file 420, block 430 representing an EM simulation tool, and block 440 representing a process of outputting an EM model.

In at least one embodiment, the EM simulation tool at block 430 executes the connection file 420, based on two or more process technology profiles from the process technology profiles 410, to generate stackup information corresponding to the combined multiple process technologies. For example, the stackup information includes a stackup of connected layers, which may include a bottom layer corresponding to CLNB, an added layer from CLNA, and a connection positioned between the CLNB and CLNA layers.

In FIG. 4B, at block 420, the EM simulation tool further receives design layouts 412 corresponding to the stacked profile layers, which are used to define a combined device. For example, in a stackup that includes CLNB and CLNA layers, the EM simulation tool may retrieve design layouts corresponding to both CLNB and CLNA to define a combined device, where a CLNA-based component is stacked upon a CLNB-based component his allows the EM simulation tool to perform simulation at block 432 and/or output an EM model at block 440.

However, it will be noted that a connection module (e.g., a connection file) containing any suitable information may be used to combine the material properties and dimensions from an arbitrary number of process technology profiles, in any suitable combination, enabling EM simulation tools to support multi-process designs and generate an output EM model, for example, as illustrated in FIG. 4A. Furthermore, the EM tools may implement the connection module to obtain sufficient material information for accepting design layouts from various process technology profiles, allowing for EM co-simulation and/or the generation of an EM model representing a specific combined device, for example, as illustrated in FIG. 4B.

At block 340, the computing system performs co-simulation on the combined device model and produces co-simulation outputs. For example, the co-simulation outputs includes one or more suitable output models that capture the interaction between multiple process technologies. In EM simulations, the output models reflect the EM behavior across the heterogeneous stackup, made possible by incorporating connections that define the electrical and physical interfaces between the different process technologies.

FIG. 5 is a flow diagram illustrating a method 500 for processing process technology profiles, in accordance with one or more embodiments of the present disclosure. Each block of method 500, described herein, may comprise a computing process that may be performed using any combination of hardware, firmware, and/or software. For example, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 500 is described, by way of example, with respect to the computing system of FIG. 1B. However, this method may additionally or alternatively be executed by any one system, or any combination of systems, including, but not limited to, those described herein. Furthermore, persons of ordinary skill in the art will understand that any system that performs method 500 is within the scope and spirit of embodiments of the present disclosure. Additionally, it will be appreciated by persons of ordinary skill in the art that the method 500 may be performed in any suitable environment and blocks in the method 500 may be performed in any suitable order.

The computing system executes a connection module to generate a stackup of connected process technology profiles. For example, the connection module includes a connection file that contains instructions and suitable information to define connections between the process technology profiles. In at least one embodiment, when the computing system executes the connection module, it instantiates a user interface (e.g., a graphical user interface or GUI) that prompts the user to input relevant information, such as the stacking order of the profiles and whether a given profile should be flipped in the stackup (e.g., whether Metal1 or MetalN of a specific profile is placed on top of the underlying profile). This input defines the interfacing material layers between the profiles. In at least one embodiment, the connection file is generated based on user input and/or default configurations. For example, default configurations may specify provisioned connections that are commonly used between predefined process technology profiles.

The computing system receives an arbitrary number (N) of process technology profiles. For example, each process technology profile is represented by a corresponding block (e.g., block 510, 512, or 514). As shown in these blocks, each process technology profile (or “profile” for short) includes multiple material layers. For example, each profile may define an arbitrary number (N) of metal layers. However, it will be understood that each profile may define a different number of layers, including layers made of other materials such as dielectrics or other suitable materials.

At block 520, the computing system accepts a connection file with layer and connectivity information from multiple process technologies. For example, the computing system receives the N number of profiles (e.g., at blocks 510, 512, and 514) and the connection file for combining these profiles.

In at least one embodiment, the computing system executes the processes within the dashed box to deliver a stackup that includes the profiles specified in the connection file. At block 522, the computing system defines different layer names for different profiles to avoid confusion. For example, the computing system assigns a unique profile layer ID (or another suitable identification) to each process technology profile to clearly identify the corresponding layers in the final stackup. Block 530 illustrates an example in which each profile layer is assigned a specific ID (e.g., “Profile1,” “Profile2,” and “ProfileN”) that uniquely represents the corresponding process technology profile.

At block 524, the computing system adjusts the layers based on the ordering specified in the connection file. For example, the connection file specifies which layer within a specific profile (e.g., which metal layer in block 510, 512, or 514) is to interface with an adjacent profile (or a metal layer therein).

At block 526, the computing system defines the connection between the profiles based on the connection file. For example, the computing system executes the connection file to generate a connection between adjacent profiles. This connection includes definitions that specify the interconnection and relative orientation of specific material layers within the respective profiles. In at least one embodiment, the computing system generates, from bottom to top in a vertical stackup, a connection between a PCB profile layer and a packaging profile layer, a connection between the packaging profile layer and an interposer profile layer, a connection between the interposer profile layer and a chiplet profile layer, among others.

At block 528, the computing system defines a complete stackup (e.g., as demonstrated in block 530) including all profile layers and the connection in between.

In the illustrated example, the complete stackup at block 530 includes the N process technology profiles from blocks 510, 512, and 514, as well as the corresponding connections, such as those represented by blocks 532 and 534.

In at least one embodiment, the connection file includes various information, such as name and layer specification, connectivity information, separation and orientation between processes, and other suitable information to define connectivity between adjacent profiles.

The method 500 may be implemented on any suitable software platform (e.g., modeling or simulation platform) to extend its capability to simulate a combined model comprising individual components defined in distinct design or simulation environments.

In at least one embodiment, the computing system may perform method 500 to generate a plurality of profile stackups representing various arbitrary combinations. For example, the generated profile stackups may be stored locally and/or in the cloud, from where they can be retrieved by the computing system or another connected system to define a specific combined device model based on their corresponding layout designs.

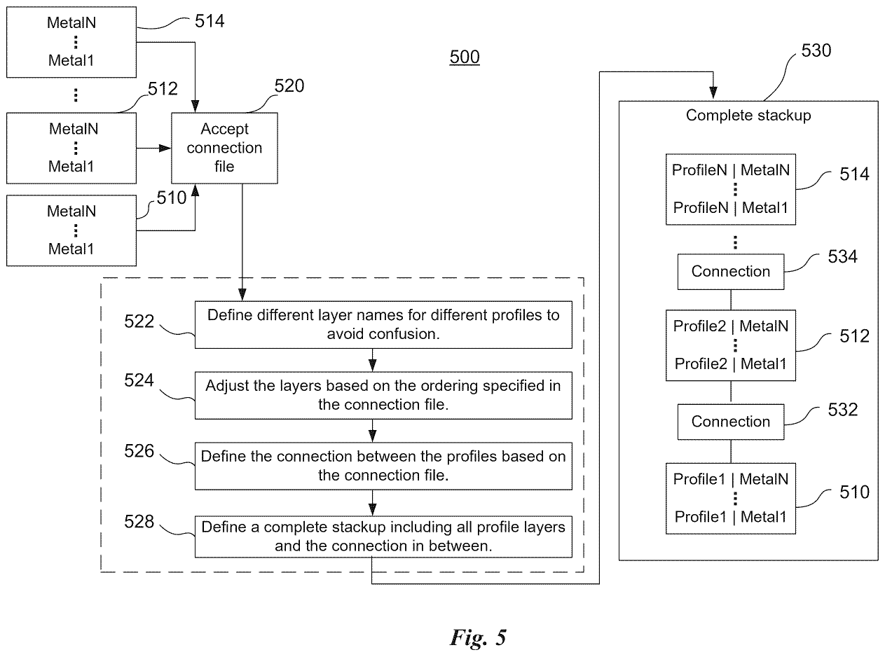

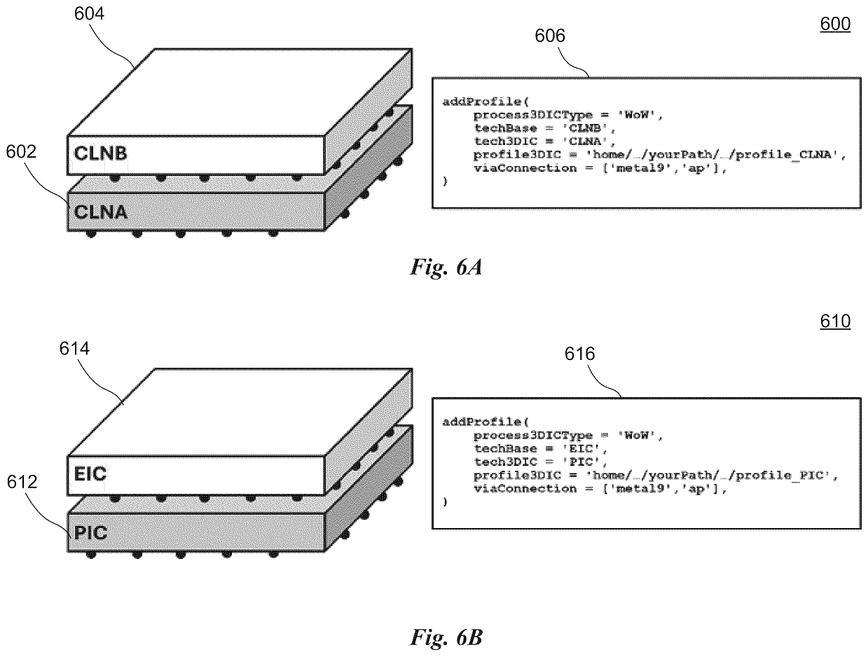

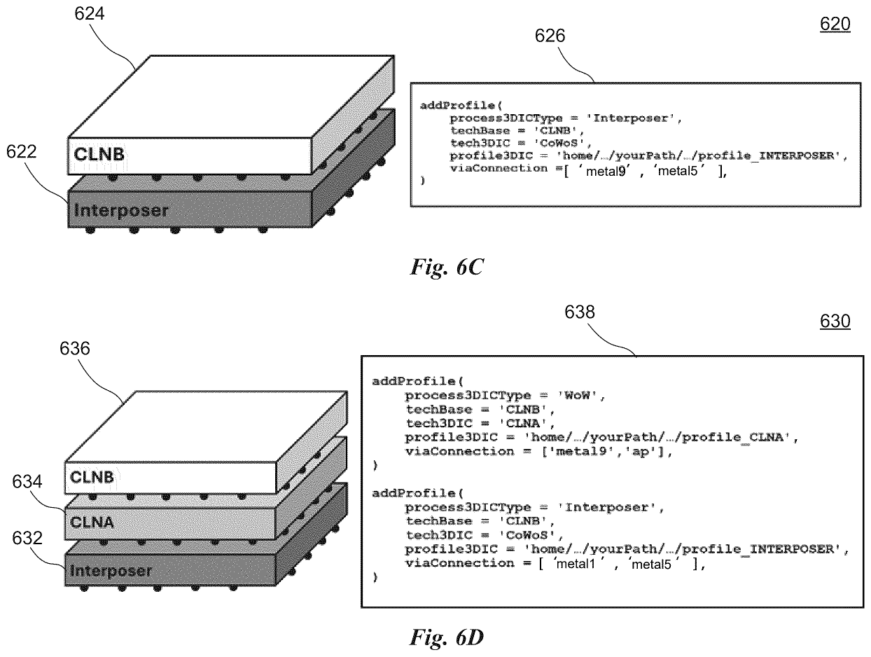

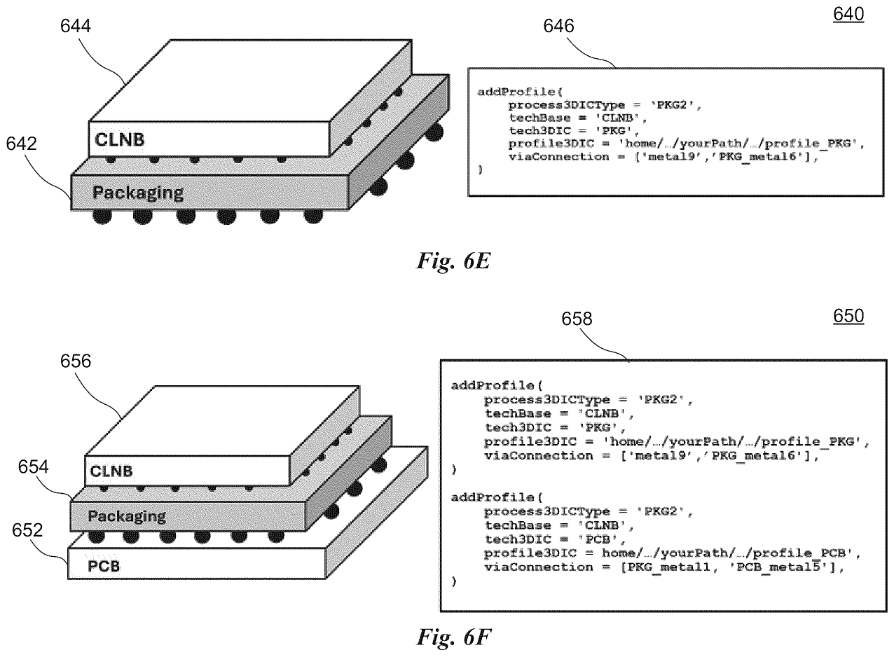

The present disclosure supports numerous variations that enable different types of microelectronic integrations, for example, by performing method 500. Some examples of these integrations may involve 3DIC architecture for Wafer-on-Wafer (WoW) applications, 2.5D interconnection with interposers, the combination of 3DIC and interposers, regular flip-chip packaging technology, the inclusion of PCB, and any combination of more than two process technology profiles. FIGS. 6A-6F illustrate examples of processing multiple process technology profiles, in accordance with some embodiments.

FIG. 6A illustrates an example of integration, in accordance with one embodiment. As shown in FIG. 6A, two IC process technologies 602 and 604 (denoted as CLNA and CLNB, respectively) are stacked in a 3DIC architecture 600 following a WoW integration. CLNA and CLNB could represent any IC process node from any foundry in the industry that are vertically combined. Block 606 illustrates example scripts included in a connection file. According to the scripts, the “metal9” layer of the CLNB profile is connected to the “ap” layer of the CLNA profile, where “ap” refers to the topmost metal layer in the respective profile.

FIG. 6B illustrates an example of integration, in accordance with one embodiment. As shown in FIG. 6B, an Electronic IC (EIC) profile 614 and a Photonic IC (PIC) profile 612 are integrated. This integration supports modeling of the latest requirements in high-speed communication. Such 3DIC integration is becoming increasingly critical for high-performance data centers. Block 616 illustrates example scripts included in a connection file. According to the scripts, the “metal9” layer of the EIC profile is connected to the “ap” layer of the PIC profile.

FIG. 6C illustrates an example of integration, in accordance with one embodiment. This example illustrates a 2.5D integration of an IC profile 624 (denoted as CLNB) with an interposer process technology profile 622. Block 626 illustrates example scripts included in a connection file. This integration may support any 2.5D interposer architecture such as the commercial Chip-on-Wafer-on-Substrate (CoWoS) technology and the Embedded Multi-Die Interconnect Bridge (EMIB). According to the scripts, the “metal9” layer of the CLNA profile is connected to the “metal5” layer of the interposer profile.

FIG. 6D illustrates an example of integration, in accordance with one embodiment. This example illustrates a combination of WoW 3DIC technology with an interposer. For example, CLNA 634 and CLNB 636 can be combined as shown in FIG. 6A, and an additional interposer process technology 632 is added to create an integration of three process technologies. This highlights the extensibility of this approach, which enables the integration of not only two processes but unlimited number of processes. Block 638 illustrates example scripts included in a connection file, which includes a first “addProfile” section for combining CLNA 634 and CLNB 636, and a second “addProfile” section for combining the interposer process technology 632 with the combined CLNB 636 and CLNA 634. According to the scripts, the “metal9” layer of the CLNB profile is connected to the “ap” layer of the CLNA profile, and then the “metal1” layer of the CLNA profile is connected to the “metal5” layer of the interposer profile. In this example, the “ap” layer of the CLNA profile may be the “metal9” layer in the CLNA profile.

FIG. 6E illustrates an example of integration, in accordance with one embodiment. This example illustrates a Flip-Chip Packaging Integration. Conventional flip-chip packaging is one of the potential applications of this disclosure, where users may want to EM simulate the effects of at least one IC profiles (e.g., CLNB 644) combined with packaging structures (e.g., corresponding to packaging profile 642) in an EM co-simulation environment. Block 646 illustrates example scripts included in a connection file. According to the scripts, the “metal9” layer of the CLNB profile is connected to the “PKG_metal16” layer of the packaging profile.

FIG. 6F illustrates an example of integration, in accordance with one embodiment. This example illustrates an IC-Packaging-PCB Integration. For example, CLNB 656 and the packaging profile 654 can be combined as shown in FIG. 6E, and an additional PCB process technology 652 is added to create an integration of three process technologies. Block 658 illustrates example scripts included in a connection file, which includes a first “addProfile” section for combining CLNB 656 and the packaging profile 654, and a second “addProfile” section for combining the PCB process technology 652 with the combined CLNB 656 and the packaging profile 654. According to the scripts, the “metal9” layer of the CLNB profile is connected to the “PKG_metal6” layer of the packaging profile, and then the “PKG_metal1” layer of the packaging profile is connected to the “PCB_metal5” layer of the PCB profile. This integration supports advanced EM analysis, which requires the integration of IC profiles with both packaging structures as well as PCB designs. However, it should be noted that the integration is not limited to only one IC profile.

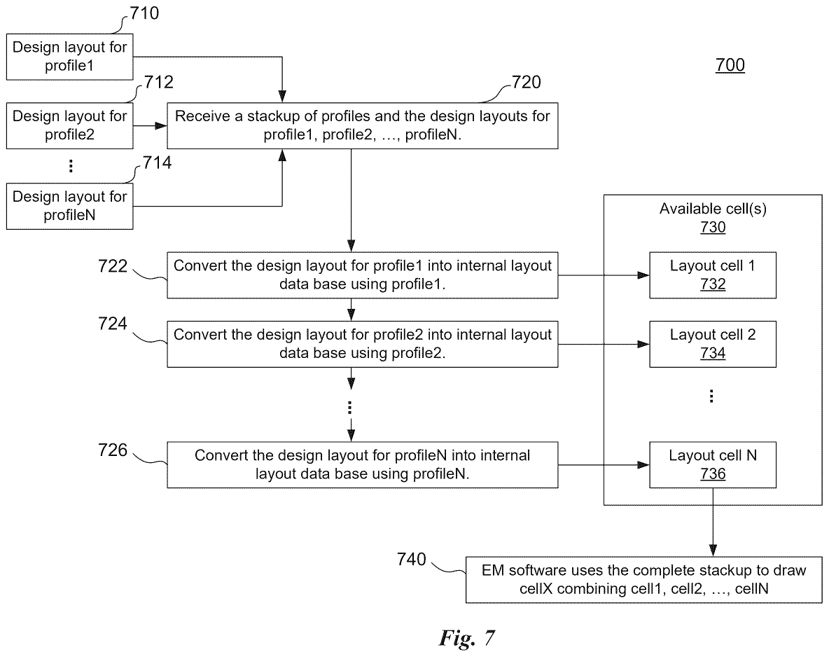

FIG. 7 is a flow diagram illustrating a method 700 for processing multiple design layouts, in accordance with one or more embodiments of the present disclosure. Each block of method 700, described herein, may comprise a computing process that may be performed using any combination of hardware, firmware, and/or software. For example, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 700 is described, by way of example, with respect to the computing system of FIG. 1B. However, this method may additionally or alternatively be executed by any one system, or any combination of systems, including, but not limited to, those described herein. Furthermore, persons of ordinary skill in the art will understand that any system that performs method 700 is within the scope and spirit of embodiments of the present disclosure. Additionally, it will be appreciated by persons of ordinary skill in the art that the method 700 may be performed in any suitable environment and blocks in the method 700 may be performed in any suitable order.

In at least embodiment, the computing system runs a suitable EM simulation tool to perform the method 700.

At block 720, the computing system obtains a stackup of process technology profiles and the corresponding design layouts from blocks 710, 712, and 714. For example, the computing system may generate the stackup of process technology profiles by performing the method 500 as demonstrated in FIG. 5. In another example, the computing system may retrieve the stackup of process technology profiles, which is generated by another computing system.

In at least one embodiment, the computing system converts the design layouts from blocks 710, 712, and 714 based on the stackup of process technology profiles, to generate available cells as illustrated in block 730. The computing system then generates a combined cell (denoted as cellX) based on the available cells 730 for modeling. It will be understood that the order of the blocks in FIG. 7 may vary, certain blocks may be omitted, and additional suitable blocks may be included as needed.

For example, at block 722, the computing system converts the design layout for profile1 into internal layout data base using profile1. This process provides a layout cell 1 732. At block 724, the computing system converts the design layout for profile2 into internal layout data base using profile2. This process provides a layout cell 2 734. At block 726, the computing system converts the design layout for profileN into internal layout data base using profileN. This process provides a layout cell N 736. Blocks for design layout conversion, such as 722, 724, and 726, may be processed in any order. The processing may be performed sequentially, in parallel, or using a hybrid approach, depending on system capabilities and implementation preferences.

At block 740, the computing system uses the stackup of profiles to construct the combined cellX 730, which combines the layout cell 1 732, the layout cell 2 734, and the layout cell N 736.

As such, the method 700 demonstrates a flow for the loading and processing of design layouts from different process technologies. With the complete stackup including multiple process technology profiles, any suitable software (e.g., EM simulation tools) can follow the flow to handle and combine layouts into different cells, which can be used for the EM co-simulation of multiple process technologies for the overall model generation.

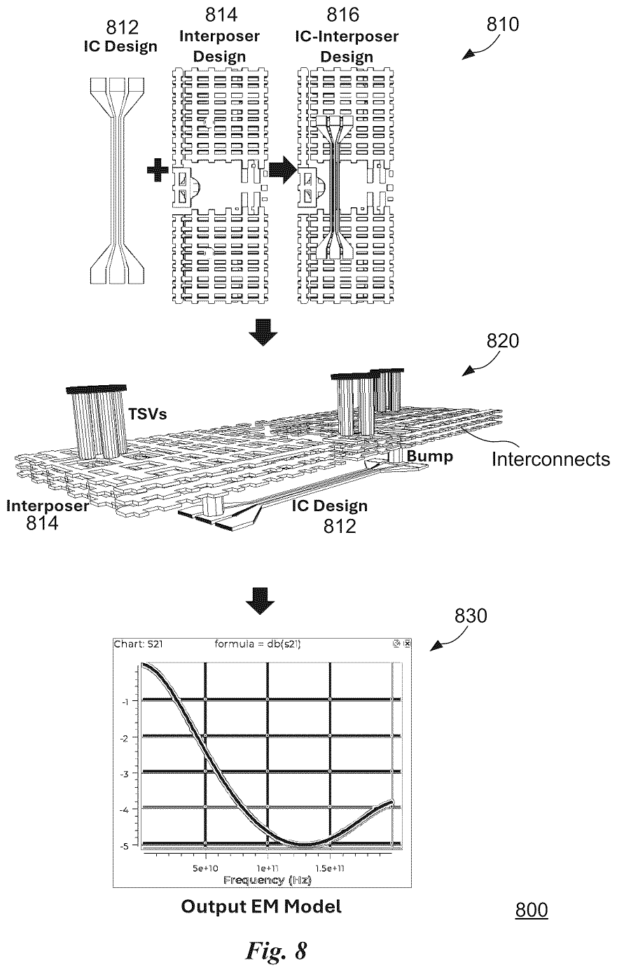

FIG. 8 illustrates an example flow 800 for EM co-simulation, in accordance with an embodiment. This example demonstrates a 2.5D Integration of an IC component with an interposer layer.

At stage 810, design layouts corresponding to two distinct process technologies are provided. In the illustrated example, the first design layout defines an IC design 812, while the second design layout defines an interposer design 814. These two layouts are combined to generate an IC-interposer layout 816, which defines the combined device to be modeled. For example, the interposer design 814 may include various components, such as TSVs, interconnects, bumps, or other suitable components.

A computing system may perform methods disclosed herein, such as method 500 and/or method 700, to construct the combined device in a suitable EM simulation tool. The computing system may generate a stackup of profiles 530 as illustrated in FIG. 5 and/or a combined cellX 730 as demonstrated in FIG. 7.

At stage 820, the computing system performs EM co-simulation on the IC-interposer design. In the illustrated example, the combined device is presented using a 3D visualization. Various parameters of interest can be modeled within the combined device, such as voltage and current distribution, electromagnetic field propagation, signal integrity, power integrity, parasitic coupling, impedance characteristics, and more. A color bar can be used in the visualization to represent the magnitude or intensity of these parameters, providing an intuitive and clear way to interpret simulation results. These parameters may be modeled in EM simulation for evaluating the electrical performance, reliability, and efficiency of the integrated system.

At stage 830, the computing system outputs an EM model that represents the simulated behavior of the combined device under study.

For example, commercial EM tools, such as PEAKVIEW®, can implement methods and/or systems disclosed herein to expand their material profile capabilities, enabling them to accept layouts from distinct process technology profiles, such as an advance node IC design and an interposer design. Once layouts from both process technologies are loaded into the EM tool, they can be combined and processed for an EM co-simulation of an IC-Interposer design. This exemplifies the application of the present disclosure to real cases regardless of the internal algorithms or numerical methods of the EM tools.

Accordingly, at stage 830, any suitable output EM model can be generated to characterize the performance of the integrated electronic process technologies across operating frequencies. The EM model shown in FIG. 8 may be represented in the form of an z-parameter, y-parameter and s-parameter file as well as equivalent circuits (e.g., RLCK netlists) and rational fitting model for circuit simulation and analysis. Other derived output EM model representations may involve visualization pictures, which describe the device performance in terms of parameters such as voltage distribution, currents, E/H-fields, etc.

In general, this integration framework enables any suitable software platform to simulate and generate models for heterogeneous integration involving multiple process technologies, thereby supporting accurate and comprehensive electromagnetic analysis.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A method for device simulation, comprising:
receiving two or more process technology profiles;
obtaining, for co-simulation based on the two or more process technology profiles, a stackup of layers comprising two or more profile layers and a connection between adjacent profile layers of the two or more profile layers; and
performing, using an electromagnetic (EM) tool, co-simulation on a three-dimensional device comprising the stackup of layers,
wherein each profile layer corresponds to a process technology profile, and
wherein the connection comprises definitions of connectivity between the adjacent profile layers.

2. The method according to claim 1, further comprising:
receiving two or more layout designs, each layout design corresponding to a process technology profile of the two or more process technology profiles;
generating, based on the stackup of layers and the two or more layout designs, a combined device stacking individual devices corresponding to the two or more process technology profiles; and
performing co-simulation on the combined device and producing co-simulation results.

3. The method according to claim 2, wherein performing co-simulation on the combined device and producing co-simulation results comprises:
generating one or more output models based on the combined device,
wherein the one or more output models comprise interactions between two or more process technologies corresponding to the two or more process technology profiles.

4. The method according to claim 3, wherein the one or more output models comprise an EM model that simulates EM behaviors in the combined device.

5. The method according to claim 1, wherein obtaining the stackup of layers is carried out by executing a connection file,
wherein the connection file comprises one or more of:
a definition of a combination of the two or more process technology profiles and an integration therebetween;
name and layer specifications;
connectivity information; or
separation and orientation between two or more process technologies corresponding to the two or more process technology profiles.

6. The method according to claim 5, wherein the connection file defines, based on user input or default configuration, an arbitrary combination of technology profiles from the two or more process.

7. The method according to claim 1, wherein obtaining the stackup of layers comprises:
obtaining, from a plurality of stackups of layers corresponding to a plurality of combinations of process technology profiles stored in a storage medium, the stackup of layers corresponding to the two or more process technology profiles,
wherein the plurality of stackups of layers corresponding to the plurality of combinations of process technology profiles are generated based on one or more connection files.

8. The method according to claim 1, wherein the two or more process technology profiles correspond to two or more different process technologies,
wherein the two or more process technologies comprises one or more of:
one or more advanced node process technologies;
at least one process technology for interposer technologies;
at least one process technology for packaging technologies; or
at least one process technology for printed circuit board (PCB) technologies.

9. The method according to claim 2, wherein the combined device is integrated based on at least one of the following integration technologies:
Wafer-on-Wafer (WoW);
integration of electronic and photonic chiplets (EIC-PIC);
Chip-on-Wafer-on-Substrate (CoWoS);
Embedded Multi-Die Interconnect Bridge;
integration of two or more integrated circuits (ICs) through interposer interconnection (IC-IC-Interposer);
flip-chip packaging integration; or
IC-Package-PCB (IC-PKG-PCB).

10. A system for device simulation, comprising one or more processors configured to:
receive two or more process technology profiles;
obtain, for co-simulation based on the two or more process technology profiles, a stackup of layers comprising two or more profile layers and a connection between adjacent profile layers of the two or more profile layers; and
perform, using an electromagnetic (EM) tool, co-simulation on a three-dimensional device comprising the stackup of layers,
wherein each profile layer corresponds to a process technology profile, and
wherein the connection comprises definitions of connectivity between the adjacent profile layers.

11. The system according to claim 10, wherein the one or more processors are further configured to:
receive two or more layout designs, each layout design corresponding to a process technology profile of the two or more process technology profiles;
generate, based on the stackup of layers and the two or more layout designs, a combined device stacking individual devices corresponding to the two or more process technology profiles; and
perform co-simulation on the combined device and producing co-simulation results.

12. The system according to claim 11, wherein performing co-simulation on the combined device and producing co-simulation results comprises:
generating one or more output models based on the combined device,
wherein the one or more output models comprise interactions between two or more process technologies corresponding to the two or more process technology profiles.

13. The system according to claim 12, wherein the one or more output models comprise an EM model that simulates EM behaviors in the combined device.

14. The system according to claim 10, wherein obtaining the stackup of layers is carried out by executing a connection file,
wherein the connection file comprises one or more of:
a definition of a combination of the two or more process technology profiles and an integration therebetween;
name and layer specifications;
connectivity information; or
separation and orientation between two or more process technologies corresponding to the two or more process technology profiles.

15. The system according to claim 14, wherein the connection file defines, based on user input or default configuration, an arbitrary combination of technology profiles from the two or more process.

16. The system according to claim 10, wherein obtaining the stackup of layers comprises:
obtaining, from a plurality of stackups of layers corresponding to a plurality of combinations of process technology profiles stored in a storage medium, the stackup of layers corresponding to the two or more process technology profiles,
wherein the plurality of stackups of layers corresponding to the plurality of combinations of process technology profiles are generated based on one or more connection files.

17. The system according to claim 10, wherein the two or more process technology profiles correspond to two or more different process technologies,
wherein the two or more process technologies comprises one or more of:
one or more advanced node process technologies;
at least one process technology for interposer technologies;
at least one process technology for packaging technologies; or
at least one process technology for printed circuit board (PCB) technologies.

18. The system according to claim 11, wherein the combined device is integrated based on at least one of the following integration technologies:
Wafer-on-Wafer (WoW);
integration of electronic and photonic chiplets (EIC-PIC);
Chip-on-Wafer-on-Substrate (CoWoS);
Embedded Multi-Die Interconnect Bridge;
integration of two or more integrated circuits (ICs) through interposer interconnection (IC-IC-Interposer);
flip-chip packaging integration; or
IC-Package-PCB (IC-PKG-PCB).

19. A non-transitory machine-readable medium for device simulation, having stored thereon a set of instructions, which if performed by one or more processors, cause the one or more processors to:
receive two or more process technology profiles;
obtain, for co-simulation based on the two or more process technology profiles, a stackup of layers comprising two or more profile layers and a connection between adjacent profile layers of the two or more profile layers; and
perform, using an electromagnetic (EM) tool, co-simulation on a three-dimensional device comprising the stackup of layers,
wherein each profile layer corresponds to a process technology profile, and
wherein the connection comprises definitions of connectivity between the adjacent profile layers.

20. The non-transitory machine-readable medium according to claim 19, further causing the one or more processors to:
receive two or more layout designs, each layout design corresponding to a process technology profile of the two or more process technology profiles;
generate, based on the stackup of layers and the two or more layout designs, a combined device stacking individual devices corresponding to the two or more process technology profiles; and
perform co-simulation on the combined device and producing co-simulation results.
